(19) United States
(12) Patent Application Publication
(10) Pub. No.: US 2025/0164115 A1
(43) Pub. Date: May 22, 2025

(54) PELLET GRILL

(71) Applicant: WH Products, LLC, Columbus, OH (US)

(72) Inventors: Michael R. Giebel, Joplin, MO (US); Paul J. Simon, Elizabethtown, KY (US); Alexandra Devi Upadhyaya, Louisville, KY (US)

(73) Assignee: WH Products, LLC, Columbus, OH (US)

(21) Appl. No.: 18/951,008

(22) Filed: Nov. 18, 2024

Related U.S. Application Data
(60) Provisional application No. 63/600,803, filed on Nov. 20, 2023.

(51) Int. Cl. F24B 13/04; A23B 4/052; A47J 37/07; F23K 3/00

(52) U.S. Cl. CPC F24B 13/04; A23B 4/052; A47J 37/0704; A47J 37/0786; F23K 3/00; F23K 2203/202

(57) ABSTRACT

A cooking grill includes a multi-compartment solid fuel hopper, a burn pot, and a tapered auger blade disposed between the solid fuel hopper and the burn pot. The grill further includes a transparent window for viewing solid fuel in the auger system, a smoke tap connected to a cooking chamber of the grill, and a steam drawer.

### CROSS-REFERENCE TO RELATED APPLICATIONS

This application claims the benefit of U.S. Provisional Application No. 63/600,803 filed Nov. 20, 2023, entitled Pellet Grill, the disclosure of which is hereby incorporated by reference herein in its entirety.

### FIELD OF THE INVENTION

Embodiments of the present invention relate to food cooking appliances.

### BACKGROUND OF THE INVENTION

Outdoor cooking, and particularly the use of outdoor barbecue grills, smokers, and griddles, remains very popular. A number of different appliances are currently available to cook food outdoors. Such appliances require some form of power and/or fuel to generate the heat required for cooking, or in some instances to power systems used to ignite and control the combustion of a given fuel. Over the years, the most popular power/fuel source has varied. Historically, popular heat/fuel sources have included electrical heating elements, wood logs and chips, charcoal briquettes, propane gas, natural gas, and more recently biomass pellets. References herein to a “pellet grill” are intended to include all barbecue grills, smokers, ovens, heaters, and griddles that use some form of pelletized (i.e., solid) fuel, whether or not such fuel is technically considered biomass fuel.

Biomass pellets have several advantages over other fuel sources for outdoor cooking. For one, biomass pellets are relatively easy and safe to transport and store. As compared with charcoal or wood, biomass pellets are also capable of providing a controlled burn rate and level of heat. Still further, biomass pellets may be manufactured to provide a particular “flavor” to the food by as a result of combusting a pellet including a particular wood type and producing smoke with that flavor. For example, a consumer may select hickory, maple, or cherry pellets, or a combination of pellet flavors, to impart a desired smoked flavor to the cooked food.

Existing pellet grills, however, do have some disadvantages as currently designed. For example, existing pellet grills typically require a continuous supply of alternating current (AC) power limiting the use of the grill to locations with such power supplies. Thus, there is a need for a pellet grill that is untethered to a continuous supply of AC electrical power, such as a battery powered pellet grill.

Known pellet grills include a single hopper for storage of solid pellet fuel for use in combustion. As previously noted, consumers may select from a variety of different wood types or pellet flavors, and in some instances may wish to mix different pellet flavors for a single cooking experience. There may be a desire to mix up to four different and distinct pellet flavors or wood types using a single hopper fill. Preferably, such flavor mixing should accommodate an even and continuous flow of each of up to four different pellet flavors from a hopper to a burn pot. Accordingly, there is a need for a pellet grill that improves the ease with which different flavors of pellet can be utilized and/or mixed together during the cooking process. There is a need for a preferred hopper and pellet delivery system that is capable of delivering a nearly constant 1:1:1:1 ratio of four different pellet types from the start to the finish of a cooking experience.

Typically, pellet grills include an auger system to deliver pellet fuel from a hopper storage compartment to a burn pot. An auger blade may convey pellets over a distance of a few inches to over twenty (20) inches for some pellet grills. On occasion, clumps of pellets may cause a jam preventing the desired flow of pellets. Such jams may not be readily apparent until the exhausted fuel in the burn pot ceases to be resupplied via the auger system. While falling temperature readings will ultimately indicate a pellet jam, this results in a departure from the desired cooking plan. Thus, there is a need for a pellet delivery system that can alert the user to a pellet jam before the pellet fuel in the burn pot is exhausted.

It is preferable for a pellet grill lid to seat evenly and closely to the grill body to maintain heat within the head unit, thereby conserving fuel expenditure. Attaching a lid to a grill body at a hinge point along the rear edge of the lid is a known method of obtaining the required seat between lid and grill body. Rear hinged lids typically must be fully opened in order to avoid the risk of the lid rapidly falling back to a closed position thereby slamming into its seat or into the arms of a user. Fully opening the lid undesirably results in great heat loss from the grill body interior even if the lid is only opened for a moment to check on or manipulate food items. Further, rear hinge lids require open space above and behind the grill to accommodate the lid when it is in the open position. Attaching a lid to a grill using a “roll-back” design is also a known method of obtaining the require seat between lid and grill body. Roll-back designs are typically easily balanced so as to reduce the risk of the lid rapidly falling back to a closed position. Roll-back designs also may offer the option of not fully opening to access food items within the grill thereby minimizing heat loss when opening the lid. Roll-back designs, however, can be relatively more complex and expensive to provide, and require space along the lower back portion of the grill to accommodate the lid when it is in the open position. Further, unless fully opened (resulting in greater heat loss) roll-back lids may block access to a warming rack provided in the upper portion of many grills. Thus, there is a need for a grill lid that has the lower expense and complexity advantages of a rear hinged lid while also providing the balanced operation and lower heat loss of a roll-back type lid. There is also a need for a grill lid that provides full access to a warming rack provided in the upper portion of grill body without the amount of heat loss that results from fully opening the lid.

Pellet grills can cook at lower temperatures over long periods of time to impart a smoked flavor to food items. The smoked flavor results from creating and maintaining a cooking chamber filled with smoke. Since a pellet grill can nearly continuously generate new supplies of smoke, a portion of such smoke can be syphoned off from the cooking chamber to impart a smoke flavor to food or drink items located outside of the cooking chamber. Thus, there is a need for a system that effectively and efficiently directs smoke resident in the cooking chamber of a pellet grill to food or drink items located outside of the cooking chamber.

Some cooking enthusiasts desire to utilize relatively “wet” smoke when cooking food items in a pellet grill. “Wet” smoke requires a combination of smoke and steam. Accordingly, there is a need for a pellet grill that effectively and efficiently generates a supply of water steam for supply to the cooking chamber during operation.

### OBJECTS OF THE INVENTION

Accordingly, it is an object of some, but not necessarily all embodiments of the present invention to provide a pellet grill that is untethered to a continuous supply of AC electrical power.

It is also an object of some but not necessarily all embodiments of the present invention to provide a pellet grill having a solid fuel hopper that permits up to four different flavors of pellet to be utilized and/or evenly mixed together during the cooking process. It is a further object of some but not necessarily all embodiments of the present invention to provide a hopper and a pellet delivery system that is capable of delivering a nearly constant and even 1:1:1:1 ratio of four different pellet types from the start to the finish of a cooking experience. In some embodiments, these objects may be achieved by providing a hopper having four distinct compartments that communicate with a tapered auger blade and that may each contain a solid fuel of a different flavor. The tapered auger may have a greater diameter proximal to the hopper and a lesser diameter proximal to a burn pot.

It is also an object of some but not necessarily all embodiments of the present invention to provide a pellet delivery system that can alert the user to a pellet jam before the pellet fuel in the burn pot is exhausted. In some embodiments, this object may be achieved by providing a transparent viewing window in the auger system that permits a user to view the conveyance of pellets through the auger system.

It is also an object of some but not necessarily all embodiments of the present invention to provide a grill lid that has the lower expense and complexity advantages of a rear hinged lid while also providing the balanced operation and lower heat loss of a roll-back type lid. It is a further object of some but not necessarily all embodiments of the present invention to provide a grill lid which allows full access to a warming rack provided in the upper portion of grill body while minimizing the amount of heat loss that results from opening the lid. In some embodiments, this object may be achieved by connecting a grill lid to a grill body using opposing brackets that each extend from an off-center pivot point on a side of the grill body to the lid.

It is also an object of some but not necessarily all embodiments of the present invention to provide a system that effectively and efficiently directs smoke resident in the cooking chamber of a pellet grill to food or drink items located outside of the cooking chamber. In some embodiments, this object may be achieved by providing a smoke tap communicating with the grill cooking chamber and connected to a side of the grill body above a grill side table.

It is also an object of some but not necessarily all embodiments of the present invention to provide a pellet grill that effectively and efficiently generates a supply of water steam for supply to the cooking chamber during operation. In some embodiments, this object may be achieved by providing a steam tray slidably received in a front portion of the grill body.

### SUMMARY OF EMBODIMENTS OF THE INVENTION

Responsive to the foregoing challenges, Applicant has developed an innovative cooking grill, comprising: a grill body defining a cooking chamber; a solid fuel hopper attached to the grill body, said hopper having four distinct pellet compartments; a burn pot disposed within or attached to the grill body; an auger system including a tapered blade extending between the hopper and the burn pot, said auger system further including a transparent viewing window; a lid attached to the grill body using opposing brackets that each extend from an off-center pivot point on a side of the grill body to the lid; a smoke tap communicating with the grill cooking chamber and connected to a side of the grill body above a grill side table; and a steam tray slidably received in a front portion of the grill body.

Applicant has further developed an innovative cooking grill, comprising: a grill body defining a cooking chamber; a solid fuel hopper attached to the grill body, said hopper having four distinct pellet compartments; a burn pot disposed within or attached to the grill body; and an auger system including a tapered blade extending between the hopper and the burn pot.

Applicant has still further developed an innovative cooking grill, comprising: a grill body defining a cooking chamber; a solid fuel hopper attached to the grill body; a burn pot disposed within or attached to the grill body; and an auger system extending between the hopper and the burn pot, said auger system including a transparent viewing window.

Applicant has still further developed an innovative cooking grill, comprising: a grill body defining a cooking chamber; and a lid attached to the grill body using opposing brackets that each extend from an off-center pivot point on a side of the grill body to the lid.

Applicant has still further developed an innovative cooking grill, comprising: a grill body defining a cooking chamber and having a side portion; a side table connected to the grill body; and a smoke tap in fluid communication with the cooking chamber and connected to the side portion above the side table.

Applicant has still further developed an innovative cooking grill, comprising: a grill body defining a cooking chamber and having a front portion; and a steam tray slidably received in the front portion of the grill body.

It is to be understood that both the foregoing general description and the following detailed description are exemplary and explanatory only and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only and should not be construed as limiting the invention.

FIG. 1 is a perspective view of the front of a pellet grill with the cooking chamber lid opened in accordance with embodiments of the invention.

FIG. 2 is a perspective view of the back of a pellet grill with the cooking chamber lid closed in accordance with embodiments of the invention.

FIG. 3 is a front view of a pellet grill with the cooking chamber lid closed in accordance with embodiments of the invention.

FIG. 4 is a front view of a pellet grill with the cooking chamber lid open in accordance with embodiments of the invention.

FIG. 5 is a front cross-sectional view of a pellet grill hopper, auger system, and head unit in accordance with embodiments of the invention.

FIG. 6 is a side view of a pellet grill auger blade in accordance with embodiments of the invention.

FIG. 7 is a side view of an auger system pellet viewing window in accordance with embodiments of the invention.

FIG. 8 is a side cross-sectional view of a pellet grill head unit with the cooking chamber lid closed in accordance with embodiments of the invention.

FIG. 9 is a perspective side cross-sectional view of a pellet grill head unit with the cooking chamber lid closed in accordance with embodiments of the invention.

FIG. 10 is a side cross-sectional view of a pellet grill head unit with the cooking chamber lid open in accordance with embodiments of the invention.

FIG. 11 is a perspective side cross-sectional view of a pellet grill head unit with the cooking chamber lid open in accordance with embodiments of the invention.

FIG. 12 is a perspective view of a pellet grill hopper with the hopper lid closed in accordance with embodiments of the invention.

FIG. 13 is a perspective view of a pellet grill hopper with the hopper lid open in accordance with embodiments of the invention.

FIG. 14 is a top down view of a pellet grill hopper with the hopper lid open in accordance with embodiments of the invention.

FIG. 15 is a perspective view of a pellet grill smoke tap in accordance with embodiments of the invention.

FIG. 16 is a perspective view of a pellet grill smoke tap head in accordance with embodiments of the invention.

FIG. 17 is a perspective view of a closed pellet grill steam drawer in accordance with embodiments of the invention.

FIG. 18 is a cross-sectional side view of a closed pellet grill steam drawer in accordance with embodiments of the invention.

FIG. 19 is cross-sectional perspective view of a closed pellet grill steam drawer in accordance with embodiments of the invention.

FIG. 20 is a perspective view of an open pellet grill steam drawer in accordance with embodiments of the invention.

### DETAILED DESCRIPTION OF EMBODIMENTS OF THE INVENTION

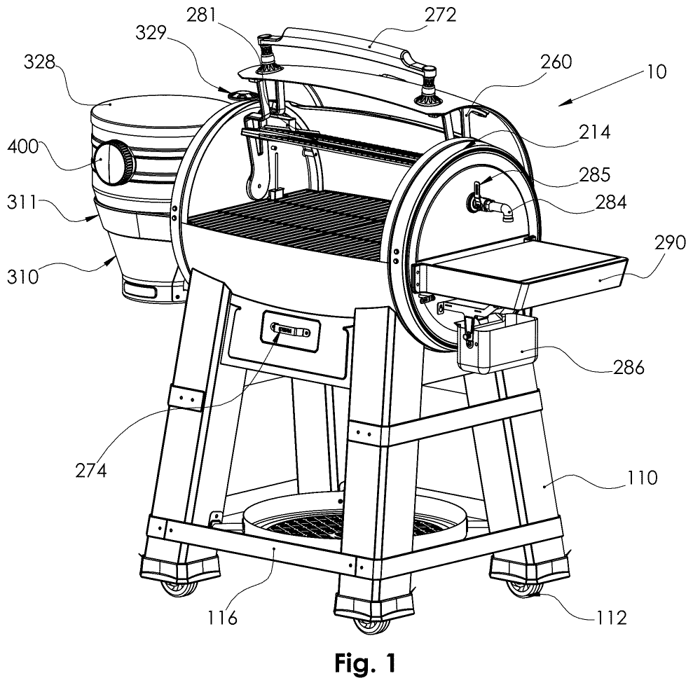

Reference will now be made in detail to embodiments of the present invention, examples of which are illustrated in the accompanying drawings. With reference to FIGS. 1-4, a pellet grill 10 may include a lower cart 100 and an upper head unit 200. The cart 100 may include two sets of interconnected base legs 110 joined by one or more cart lateral supports 116 using fashioners, such as screws, bolts, cotter pins, or the like. The cart legs 110 may be provided with caster wheels 112 and wheel locks. The leg tops 118 may be formed to connected securely to the barrel-shaped head unit 200. The size, shape, and design of the cart 100 may be varied without departing from the intended scope of the invention. For example, in alternative embodiments, the cart may include an enclosed cabinet for storage and/or esthetic purposes.

The head unit 200 may be generally barrel-shaped so as to have a generally cylindrical form having a larger diameter at its lateral central as compared with its right and left sides. The barrel shape of the head unit 200 is formed in part by the rear wall 216 which transitions to an underside and lower front portion seamlessly all having the same barrel curvature. The opening in the head unit 200 may be covered by a grill lid 260. The head unit 200 may include a largely hollow cooking chamber or grill body 210 having a left side wall 212, and a right side wall 214, respectively which are capped by circular end rings that mate with the grill lid 260. A grease receptacle 286 may be removably connected to the right side of the grill body 210.

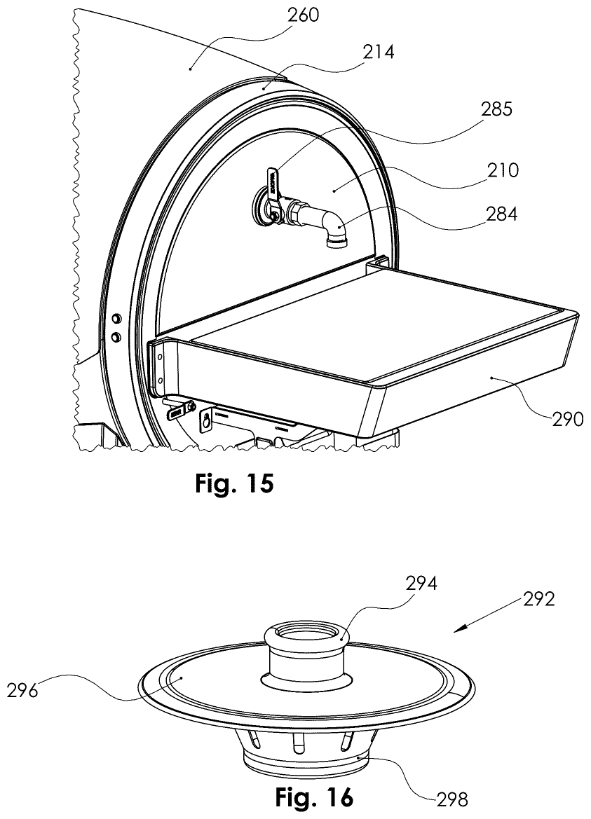

With reference to FIGS. 1-4 and 15-16, a side table 290 may be connected to the grill body 210 along the outside of the right side wall 214 by one or more fashioners above the grease receptacle 286. The side table 290 may have an upper planar horizontal surface adapted to support utensils, plates, trays, food containers, drink containers, and the like. A hollow pipe formed into a smoke tap 284 may be connected to the right side wall 214 of the grill body 210. The smoke tap 284 may communicate with the interior of the grill body 210 such that smoke in the grill body may flow through the smoke tap 284 towards the ambient. Control over the flow of smoke through the smoke tap 284 may be controlled by a tap valve 285 that pivots between open and closed positions and which is attached to the smoke tap. The outer most end of the smoke tap 284 may be fitted with a tap head 292 made of soft and/or flexible material such as natural or synthetic rubber, neoprene, or the like. The tap head 292 may be removably connected to the smoke tap 284 using a male-female head connector 294 which is preferably sufficiently deformable that it can be stretched over the end of the smoke tap. The tap head 292 may include a relatively planar head disk 296 extending outward from a mid-portion and a lower head outlet 298. The diameter of the head disk 296 is preferably sufficient to temporarily seal the open end of a drink container, such as a whiskey glass. The tap head may have a central passage extending from the head connector 294 to the head outlet 298 for the passage of smoke from the grill body 210. The head outlet 298 may include a plurality of side wall openings configured to permit smoke to pass therethrough. The head outlet 298 may have an open or covered lower most end. The flexible characteristic of the tap head 292 permits drinking containers to be pressed upward against the head disk 296 without fear of damage so that smoke may be infused into the liquid in the drinking glass.

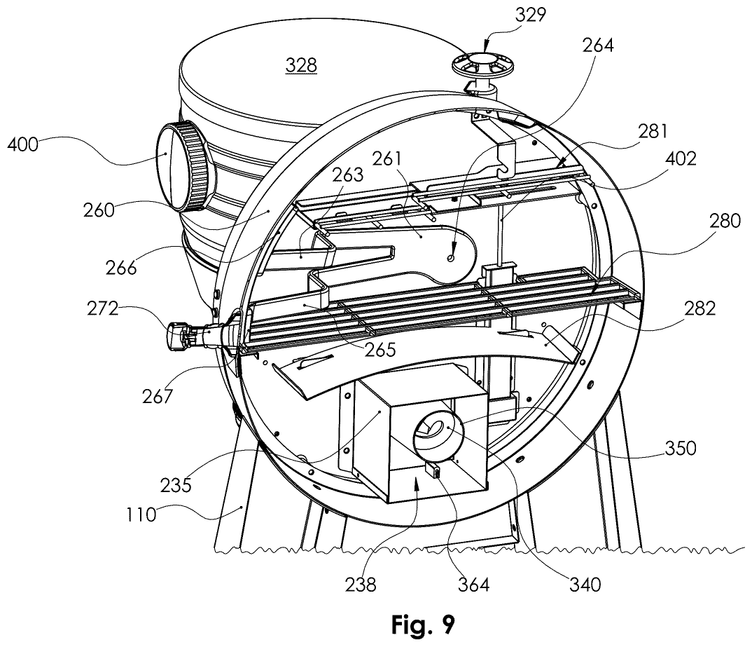

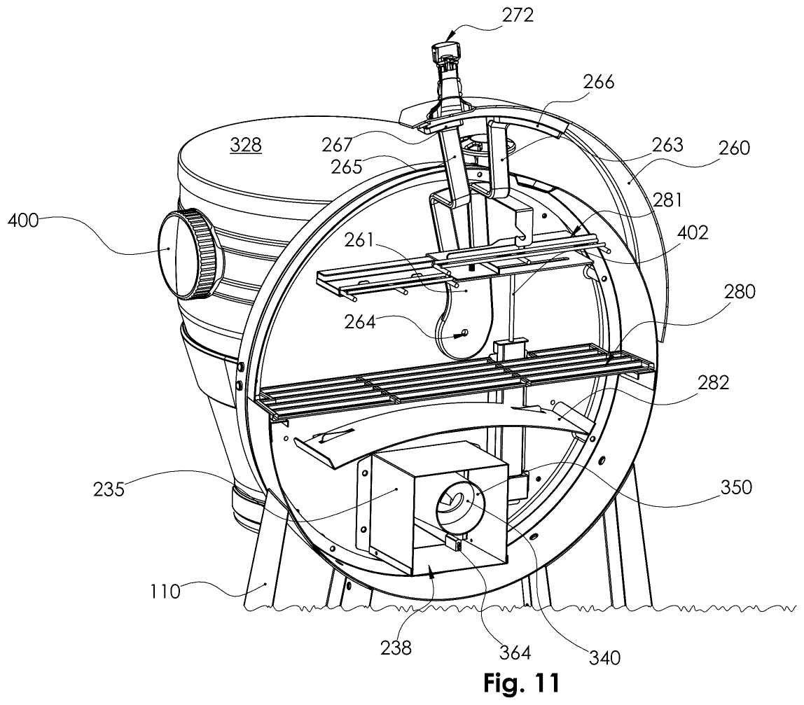

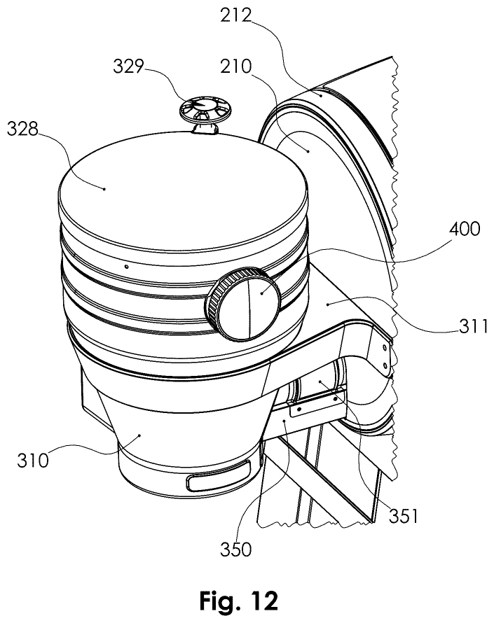

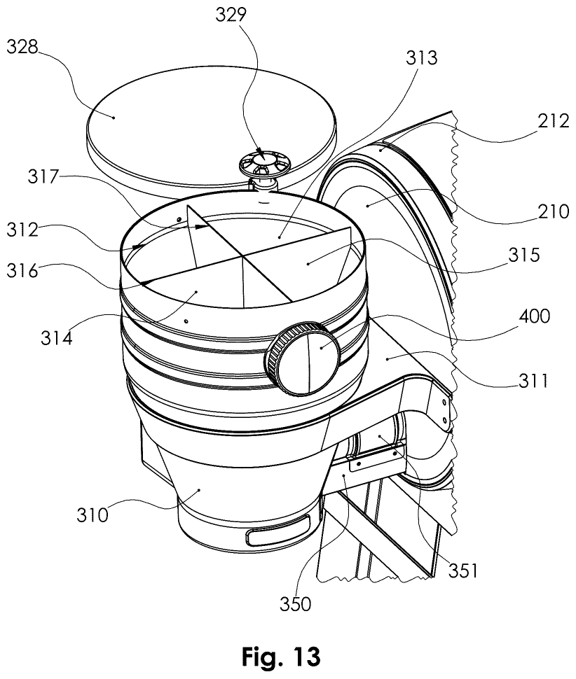

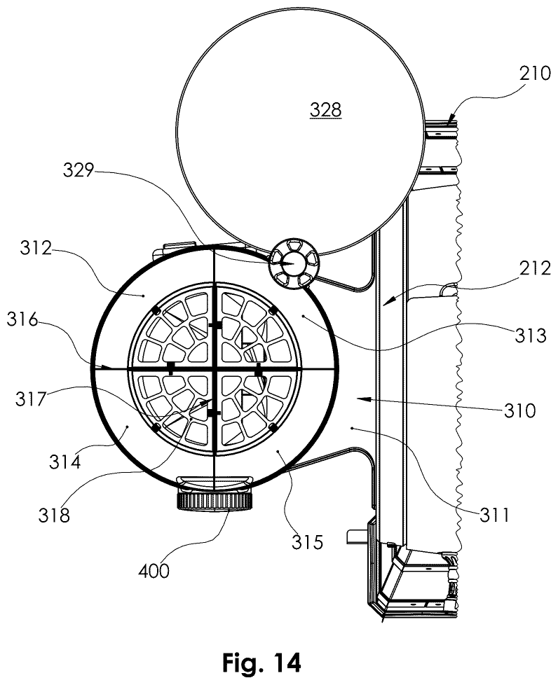

With reference to FIGS. 1-5, 9 and 11-14, a pellet hopper 310 may be connected to the left side wall 212 of the head unit 200 by a hopper bracket 311. The outer shell of the pellet hopper 310 may have an upright generally cylindrical upper portion above the hopper bracket 311. The upper open end of the pellet hopper 310 may be covered by a removeable or moveable hopper lid 328. A lid handwheel 329 may be used to secure the hopper lid 328 to the hopper 310. Manipulation of the lid handwheel 329 may be used to loosen or tighten the hopper lid 328 in place over the upper opening of the pellet hopper 310. When the handwheel 329 is loosened, the hopper lid 328 may swing clockwise to uncover the upper end of the pellet hopper 310 as shown in FIG. 13.

The outer shell of the pellet hopper 310 below the hopper bracket 311 or below the grill body 210 may taper inwardly from top to bottom to form a frusto-conical shape. This tapered outer shell portion of the pellet hopper 310 transitions the outer shell diameter between its maximum above the hopper bracket 311 to its minimum at the point that the outer shell meets the auger housing 350. The upper side wall of the pellet hopper 310 may include a control knob 400 with a readout panel. The control knob 400 may be wirelessly or plug-in connected to various electrical components in the grill, such as a battery system, auger motor, fan assembly, and pellet ignition system.

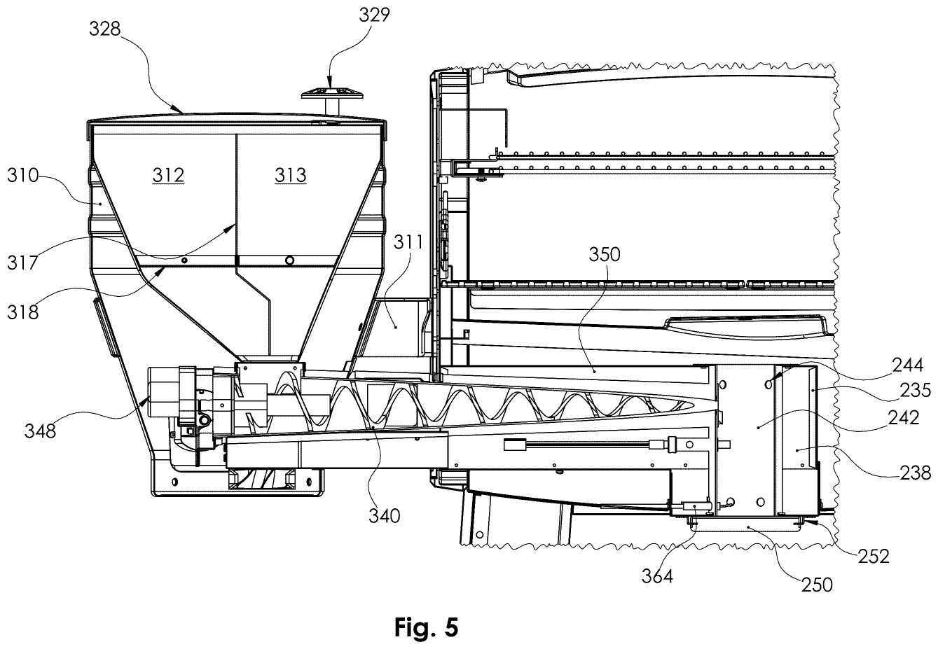

With reference to FIGS. 5, 13 and 14, the interior of the pellet hopper 310 may be divided into four compartments, namely, a first hopper compartment 312, a second hopper compartment 313, a third hopper compartment 314, and a fourth hopper compartment 315 using two perpendicularly oriented upright divider walls, namely, a first hopper divider wall 316 and a second hopper divider wall 317. Each of the hopper compartments may be used to store different types/flavors of pellet fuel. The outer side walls of the four hopper compartments 312, 313, 314 and 315 may be curved and slope inwardly from top to bottom forming a funnel shape leading to an opening in the auger housing 350. This inward slope of the outer side walls of the four hopper divider walls is selected to promote the flow of pellets in a downward direction under the influence of gravity. A pellet screen 318 having a plurality of openings configured to sift and de-clump pellets may be disposed within the pellet hopper 310 in a generally horizontal position relative to the upright divider walls 316 and 317.

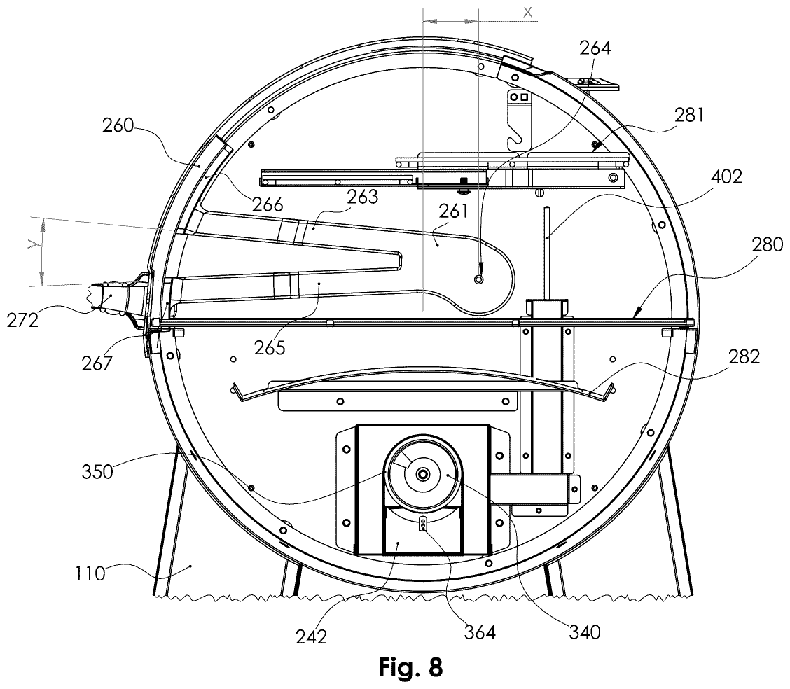

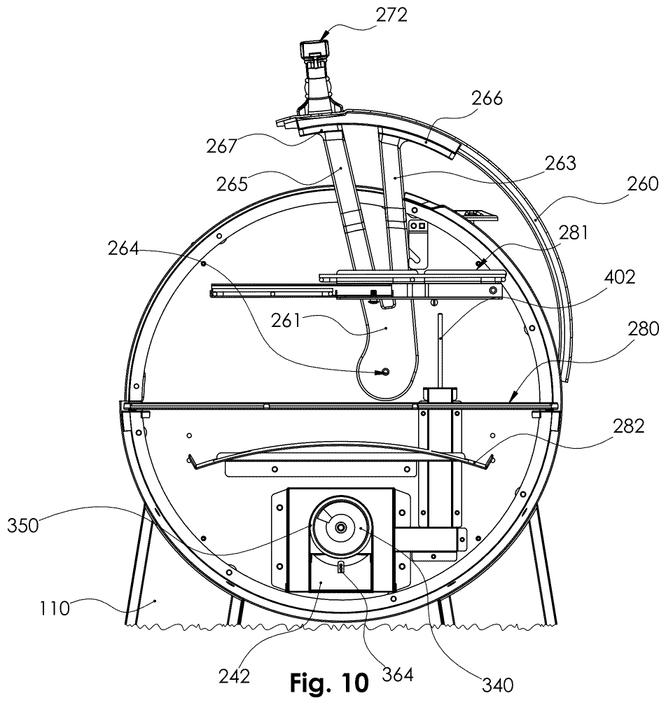

The interior of the head unit 200 is shown in FIGS. 1, 4, 5 and 8-11. A warming rack 281 may be disposed above a cooking surface 280. The warming rack 281 may include a lower portion that may be selectively moved forward and backward to increase or decrease the effective area of the warming rack. With reference to FIGS. 8-11, a bowed grease plate 282 may be disposed at an incline below the cooking surface 280. The central upward bow of the grease plate 282 may form two side channels to encourage the smooth flow of grease towards a grease drip port (not shown). Grease collected on the grease plate 282 flows downward through the grease drip port and into a grease receptacle 286 (shown in FIGS. 1-4). Disposable liners may be provided for the grease receptacle. A Resistance Temperature Detector (RTD) 402 may be mounted along an interior wall of the grill body 210. The RTD 402 may be electrically connected to the readout panel/controller 400.

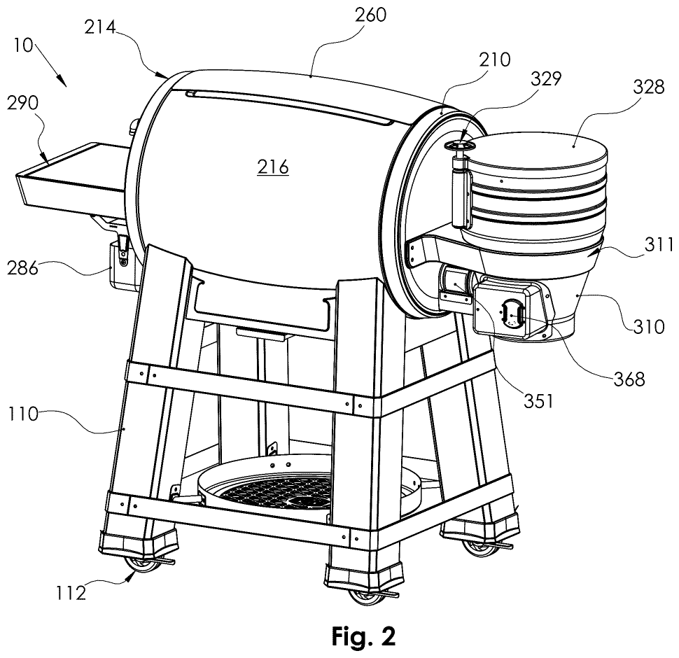

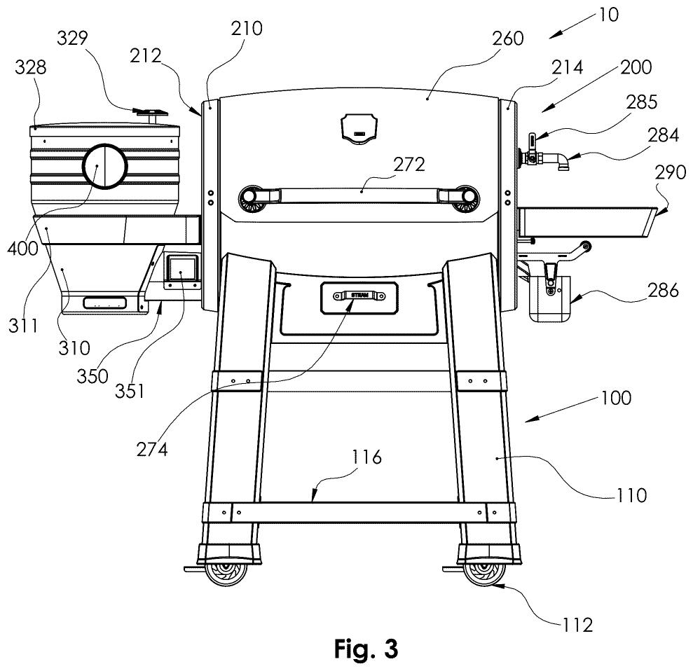

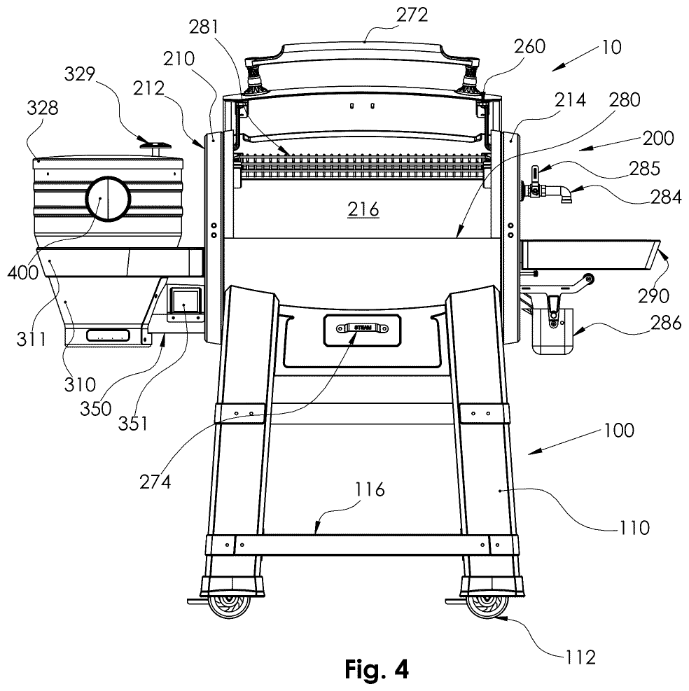

With reference to FIGS. 1-4 and 8-11, the pivoting grill lid 260 may have a front contoured or bowed handle 272. The lid 260 is shown in a closed position in FIGS. 2 and 3; and the lid is shown in an open position in FIGS. 1 and 4. The grill lid 260 may be connected to the left side wall 212 and right side wall 214 by lid brackets 261. For ease of discussion, the connection of the grill lid 260 to the left side 212 using a lid bracket 261 will be explained, however it is appreciated that connection to the right side 214 is made in like manner. The lid bracket 261 is connected to the left side wall 212 by a pivot shaft 264. The pivot shaft 264 is offset from the center of the circular left side wall 212 rearward of the center by a distance x in the range of 0 to 4 inches, more preferably in the range of 1 to 3 inches, and even more preferably in the range of 1.5 to 2.5 inches. The pivot shaft 264 is offset above the left side wall center by a distance in the range of 0 to 3 inches, more preferably in the range of 1 to 2 inches, and even more preferably about 1.4 inches. The lid bracket 261 may include an upper arm 263 and a lower arm 265 which extend forward from the pivot shaft 264 region to the grill lid 260. The upper arm 263 may connect to the grill lid 260 at an upper connection flange 266; and the lower arm 265 may connect to the grill lid at a lower connection flange 267. The upper arm 263 and the lower arm 265 may have longitudinal axis which diverge from each other at an angle y in the range of 0 to 15 degrees, or more preferably about 8 degrees. The divergence may be zero when the upper arm 263 and the lower arm 265 are merged into a single arm. The upper arm 263 and the lower arm 265 may each include an S-bend approximately at a mid-point of each arm that is configured to accommodate the arms pivoting freely and clear of the warming rack 281 when the rack is in a retracted position. The S-bend transitions the upper arm 263 and the lower arm 265 from being closely adjacent to the left side wall 212 at the portion of the arms proximal to the pivot shaft 264 to being spaced in the range of 1 to 3 inches, or more preferably approximately 2 inches from the left side wall at the portion of the arm distal from the pivot shaft. Preferably, the lid 260 may be configured to pivot through close to ninety (90) degrees of arc, or more preferably, more than ninety (90) degrees of arc in some embodiments. Due to the offset position of the pivot shaft 264, when opened, the grill lid 260 lifts up and away from the grill body 210. When closed, the grill lid 260 seals cleanly within a recess flanges provided along the left side wall 212 and right side wall 214 end caps so that the grill lid is flush or nearly flush with the end caps outer most surfaces. The relative weight of the grill lid 260, upper connection flange 266 and lower connection flange 267, as well as the pivot range of the grill lid, are selected so that the grill lid is well balanced and opens smoothly with a constant light touch throughout its pivoting and so that it seats smoothly and lightly at both the full open and full closed positions. For example, appropriate balance may be achieved by making the upper connection flange 266 heavier and/or larger than the lower connection flange 267 by a ratio in the range of 1.5:1 to 3:1, or more preferably by a ratio of about 2:1.

With reference to FIGS. 5-14, the bottom ends of the four hopper compartments 312, 313, 314 and 315 may be open so that fuel pellets may drop from the hopper compartments into an auger housing 350. The auger 340 may be supported by one or more auger bearings. An auger motor 348 may drive the auger 340 at various predetermined speeds and/or for various durations under the control of the controller 400. The auger motor 348 may drive the auger 340 at one or more predetermined speeds and/or predetermined durations to provide a desired amount of fuel based on measured temperatures in the cooking chamber (i.e., the area above the cooking surface 280) and/or measured temperatures in the heating chamber (i.e., the area below the cooking surface). Temperature measurements may be taken using the RTD 402.

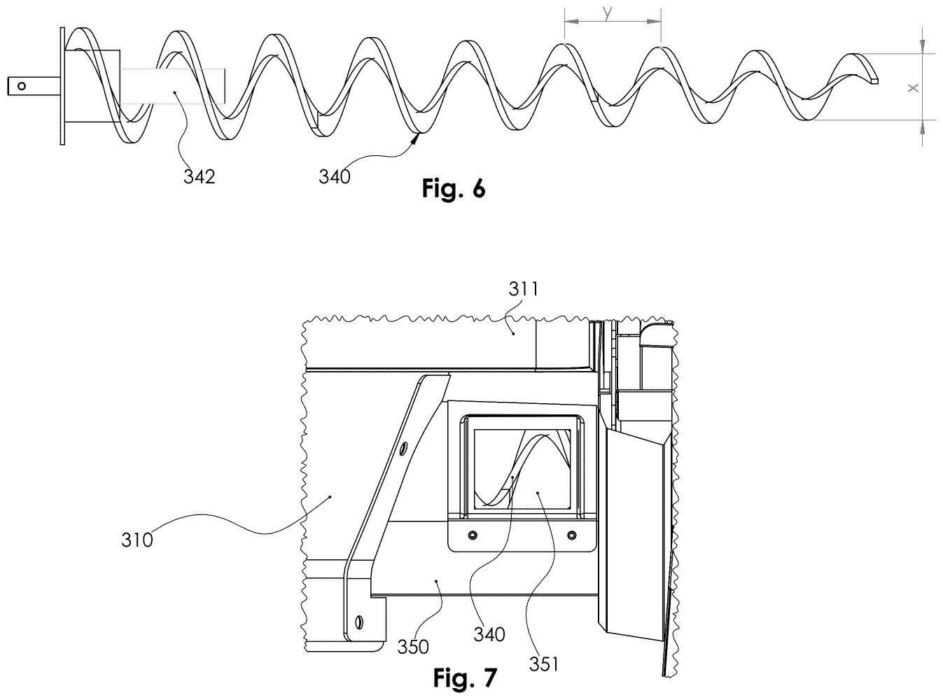

With particular reference to FIG. 6, the auger housing 350 may encase a tapered auger blade 340 having a constant pitch y (i.e., the distance between flights of the auger blade) in the range of 2.5 to 3 inches, and having a maximum diameter at its base in the range of 3 to 4 inches, or more preferably in the range of 3.2 to 3.5 inches, and a minimum diameter x in the range of 1.7 to 2.1 inches, or more preferably about 1.9 inches at the end opposite to the base. The preferred “slope” (i.e., the ratio of the decrease in diameter to the length) of the tapered auger blade is in the range of 0.06:1 to 0.07:1. The tapered auger blade may not have a center shaft, but may include an auger blade center piece 342 may extend away from the auger blade base through approximately one pitch of the auger blade 340. The auger blade center piece 342 may be a solid rod approximately a third of the diameter of the auger blade 340 at its base. The auger blade center piece 342 may reduce the likelihood of clumping and jamming of pellets in the tapered auger blade 340. Pellet jams may be viewed through one or more transparent windows 351 provided in the auger housing 350. Preferably the one or more windows 351 may be constructed of hard impact resistant plastic.

With renewed reference to FIGS. 5-14, the auger housing 350 and auger blade 340 may terminate at a burn pot 242. The burn pot 242 may include a number of openings 244 to provide air flow from outside of the housing to its interior. A dual ignitor or electrode 364 may extend through the walls of the burn pot 242 into the interior of the burn pot. The electrode 364 may include two tips separated by an air gap across which a continuous spark may be provided to ignite pellets in the burn pot 242. Alternatively, the electrode 364 may be a resistive heating element also known as a “hot rod.” The electrode 364 may be retained in place using a pressure fit with the burn pot or other fastening means. An electrical connector may connect the electrode 364 to a spark generator that is in electrical communication with, and powered by, AC system or the battery system 368 (FIG. 2). It is appreciated that the battery system 368 may include at least two or more individually removeable battery packs or batter modules.

The burn pot 242 may be connected to a fan assembly 238 that may be used to draw air through fan intake vents and thereafter direct the air to the burn pot 242 via fan duct 235. The controller 400 may be used to control the speed of the fan assembly 232, the speed of the auger 340, and/or the electrode 364 to provide a selective level of pellet combustion and heat generation in the burn pot 242. The controller may use a feed-back loop including one or more of the RTDs 402 to provide a selected level of heat in the cooking chamber. The battery system 368 may be of sufficient amperage and/or wattage to provide several hours of cooking operation in terms of power for the auger 340, the fan assembly 232, and the electrode 364.

The grill body 210 may include two opposing flanges, rails or tracks 252 configured to slidingly receive a removeable ash cup 250. The ash cup rails 252 may be provided so that the ash cup 250 may slide forward and away from the grill body 210. The ash cup 250 may have a forward portion with a raised surface that is essentially flush with the bottom of the grill body 210, and a rear portion with a depression that is configured to collect ash as the ash cup is pulled forward. The ash cup 250 may be removed for solid fuel ash clean-out, or unburned solid fuel clean-out/replacement.

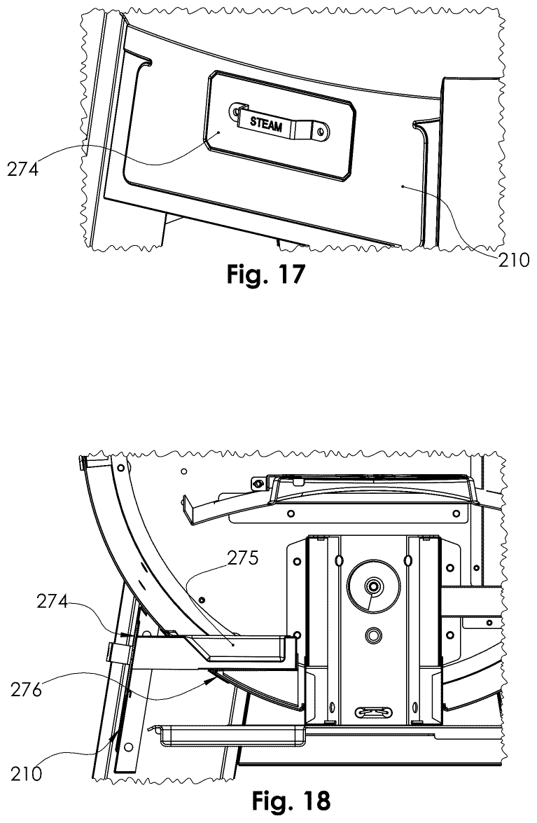

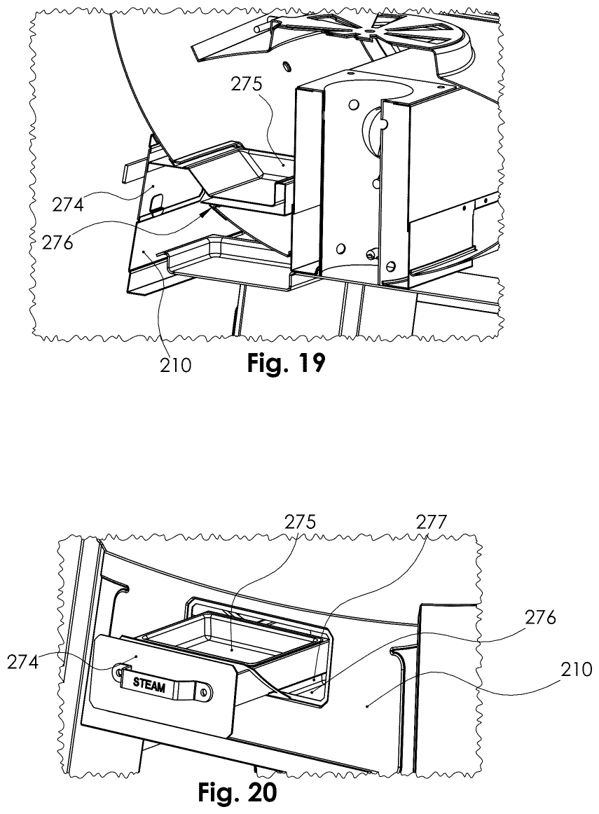

With reference to FIGS. 1, 3-4 and 17-20 a steam drawer 274 that may be received in a cavity 276 provided in the front of the grill body 210. The steam drawer may slide on two opposing drawer guides 277 extending along laterally opposed sides of the cavity 276. The steam drawer 274 may include a water cup 275 configured to hold liquid water which is available to be converted to steam as a result of being heated by the adjacent burn pot (342, FIG. 5).

As will be understood by those skilled in the art, the invention may be embodied in other specific forms without departing from the spirit or essential characteristics thereof. The elements described above are provided as illustrative examples for implementing the invention. One skilled in the art will recognize that many other implementations are possible without departing from the present invention as recited in the claims. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed:

1. A cooking grill, comprising:
a solid fuel hopper;
a burn pot;
a tapered auger blade disposed between the solid fuel hopper and the burn pot, said tapered auger blade having a first end proximal to the solid fuel hopper and a second end distal from the solid fuel hopper;
wherein the tapered auger blade has a first diameter at the first end that is greater than a second diameter at the second end.

2. The cooking grill of claim 1 wherein the tapered auger blade has a constant pitch between the first end and the second end.

3. The cooking grill of claim 1 wherein the tapered auger blade has a constant slope defined as a ratio of the decrease in diameter of the tapered auger blade to the length of the tapered auger blade, said constant slope extending between the first end and the second end.

4. The cooking grill of claim 3 wherein the constant slope of the tapered auger blade is in the range of 0.06:1 to 0.07:1.

5. The cooking grill of claim 1 further comprising:
a center piece disposed within the tapered auger blade at the first end, said center piece extending from the first end past at least one flight of the tapered auger blade.

6. The cooking grill of claim 5 wherein the center piece has a diameter that is approximately one third of the first diameter of the tapered auger blade at the first end.

7. The cooking grill of claim 1, further comprising:
an auger housing surrounding the tapered auger blade; and
a transparent window provided in the auger housing.

8. The cooking grill of claim 1, wherein the solid fuel hopper includes at least three distinct chambers configured to store solid fuel pellets.

9. The cooking grill of claim 1, further comprising:
a cooking chamber having a side portion;
a smoke tap connected to the side portion, said smoke tap in selective fluid communication with the cooking chamber; and
a tap valve connected to the smoke tap, said tap valve configured to move between open and closed positions to control flow of smoke fluid through the smoke tap.

10. The cooking grill of claim 1, further comprising:
a cylindrical or barrel shaped cooking chamber body having opposing side walls, each said side wall having a center; and
a curved lid attached to the cooking chamber body by two opposing brackets, said curved lid having a lower front portion configured to support a handle,
wherein each of the brackets is pivotally attached to a corresponding one of the opposing side walls at a location offset horizontally backward and offset vertically upward from a corresponding one of the side wall centers, and
wherein each of the brackets is attached to the lower front portion of the curved lid.

11. The cooking grill of claim 10, further comprising:
a smoke tap connected to one of the two opposing side walls, said smoke tap in selective fluid communication with an interior of the cooking chamber body; and
a tap valve connected to the smoke tap, said tap valve configured to move between open and closed positions to control flow of smoke fluid through the smoke tap.

12. The cooking grill of claim 10, wherein each of the brackets includes an S-bend located at approximately a mid-point of each of the brackets.

13. The cooking grill of claim 1, further comprising:
a grill body having a front portion; and
a steam tray slidably received in the front portion of the grill body.

14. The cooking grill of claim 9, further comprising:
a steam tray slidably received in the cooking chamber.

15. A cooking grill, comprising:
a cylindrical or barrel shaped cooking chamber body having opposing side walls, each said side wall having a center; and
a curved lid attached to the cooking chamber body by two opposing brackets, said curved lid having a lower front portion configured to support a handle,
wherein each of the brackets is pivotally attached to a corresponding one of the opposing side walls at a location offset horizontally backward and offset vertically upward from a corresponding one of the side wall centers, and
wherein each of the brackets is attached to the lower front portion of the curved lid.

16. The cooking grill of claim 15, further comprising:
a smoke tap connected to one of the two opposing side walls, said smoke tap in selective fluid communication with an interior of the cooking chamber body; and
a tap valve connected to the smoke tap, said tap valve configured to move between open and closed positions to control flow of smoke fluid through the smoke tap.

17. The cooking grill of claim 16, wherein each of the brackets includes an S-bend located at approximately a mid-point of each of the brackets.

18. The cooking grill of claim 15, wherein each of the brackets includes an S-bend located at approximately a mid-point of each of the brackets.

19. A cooking grill, comprising:
a solid fuel hopper;
an auger housing extending from the solid fuel hopper; and
a transparent window provided in the auger housing.

20. A cooking grill, comprising:
a cooking chamber body having opposing side walls;
a smoke tap connected to one of the two opposing side walls, said smoke tap in selective fluid communication with an interior of the cooking chamber body; and
a tap valve connected to the smoke tap, said tap valve configured to move between open and closed positions to control flow of smoke fluid through the smoke tap.
